(19) United States
(12) Patent Application Publication
(10) Pub. No.: US 2016/0107515 A1
(43) Pub. Date: Apr. 21, 2016

(54) TONNEAU COVER HIDDEN SNAP SYSTEM

(71) Applicants: Hang Shi, Changzhou City (CN); Hongjuan Zheng, Changzhou City (CN)

(72) Inventors: Hang Shi, Changzhou City (CN); Hongjuan Zheng, Changzhou City (CN)

(21) Appl. No.: 14/885,407

(22) Filed: Oct. 16, 2015

Related U.S. Application Data
(60) Provisional application No. 62/066,541, filed on Oct. 21, 2014.

(51) Int. Cl. B60J 7/10; B60J 7/19; B60P 7/04

(52) U.S. Cl. CPC B60J 7/104; B60P 7/04; B60J 7/198

(57) ABSTRACT

A tonneau cover system for a pickup truck cargo bed incorporates a series of hidden collapsible snap heads used to retain the tonneau cover to an internal frame work which serves to secure the covering system to the cargo bed. These hidden snap heads are covered by the fabric covering of the cover and sewn to the underside of the covering fabric. The hidden snaps are received by a longitudinal hollowed cavities located within the outward rails of the internal frame work. By working in tandem the rails and cover provide slid-ability for accessing stowed cargo.

### CROSS REFERENCE TO RELATED APPLICATIONS

This application claims benefit of U.S. provisional patent application Ser. No. 62/066,541, filed Oct. 21, 2014, the entire disclosure of which is herein incorporated by reference in its entirety.

### FIELD OF THE INVENTION

In general the present invention relates to a fabric cargo bed cover, but more particularly to a series of snaps used to fasten a fabric cargo bed cover to an internal frame work to provide cover slide-ability.

### BACKGROUND AND RELATED ART

Tonneau covers have been used for a number of years to cover the cargo box of pickup trucks. These covers protect the interior of the cargo box against rain, snow, dirt, debris and other environmental contaminants and in some cases, to improve the aesthetic quality of the vehicle.

Originally, tonneau covers were designed by upholstery shops and were typically made of vinyl covered fabrics or canvas. The material was often doubled over itself along its leading edges for added strength and appearance. Metal snaps were then attached to the sides of the cargo box with receiver metal snaps attached along the outer edges of the tonneau cover.

Wooden bows were often used to span the cargo box to ensure that the tonneau cover remained high enough to drain water from the cover, preventing accumulation of water, and hence weight, on the cover. Unfortunately these covers were sometimes difficult to handle, shrank during cold weather thereby making them difficult to re-install after removal and storage. Additionally over time rust would form around the metal snaps along the cargo bed causing corrosion issues.

Over the years a wide variety of cargo bed cover designs have been developed, in general these covers are known as either “caps” or “tonneau covers.” Caps are typically an enclosure that extends substantially above the bed so as to increase the height of the cargo bed. Tonneau covers on the other hand typically lie substantially flush with the top walls of the cargo bed without significantly increasing the height of the cargo bed.

Most tonneau cover systems today are constructed of hard plastics, glass fiber reinforced composites or waterproof fabric materials. All types of tonneau cover systems typically employ an internal support frame which installs to the cargo bed to provide support for a one piece covering assembly. Occasionally covering assemblies are hinged to provide opening sections to allow access to stowed cargo. Clamps are often employed to allow easy alignment and installation of the covering assembly to the cargo bed.

An example of a snap system can be viewed in U.S. Pat. No. 5,365,994 A to Wheatley (hereinafter “Wheatley '994”). Wheatley '994 discloses that snap fasteners are commonly used to fasten a fabric member to a frame. For example, they may be used to connect a tonneau cover to the cargo box of a pickup truck; see for example, U.S. Pat. No. 4,848,824, which was issued Jul. 18, 1989 to Gerald N. Smith, et al.

A problem with conventional fasteners is that a tonneau cover tends to expand and contract, depending upon weather conditions. Often it is difficult to adjust the cover's tautness if the fasteners on the truck are in a fixed position with respect to the direction the cover must be pulled to increase its tautness.

Another example of a snap system used to retain a tonneau cover system to a cargo bed can be viewed in U.S. Pat. No. 5,772,273 A granted to Wheatley (hereinafter “Wheatley '273”). Wheatley '273 discloses that a soft tonneau cover for pickup trucks typically have two major components. The first is a flexible sheet cover, such as a vinyl coated fabric and second, a rectangular frame attached to the pick-up truck cargo box. The frame and cover include “slidable snaps” along the length of the frame rail.

U.S. Pat. No. 5,511,843 A to Isler et al, disclose a slant rail tonneau cover assembly that provides a removable perimeter multiple rail frame with adjustably positioned snap fasteners.

All the above patents disclose snap and internal frame methods used in the attachment of a covering assembly to a cargo bed. The above patents are herein incorporated by reference in their entireties.

In response to the needs of some, or all, of the aforementioned methods and systems utilized in the snap attachment of a tonneau cover system to the cargo bed of a pickup truck will be addressed by the present invention. These and other features and advantages that may be incorporated into certain embodiments of the invention will become more fully apparent from the following description and appended claims.

### SUMMARY OF THE INVENTION

A primary object of the present disclosure is to provide a hidden snap system and method incorporated as part of a soft fabric cover and, in some embodiments where these hidden snaps integrate within the internal frame for attachment purposes. This not only improves the aesthetic look of the covering system, but it also provides slide-ability of the cover to allow access to stowed cargo contained in the bed of a pickup truck.

Cargo bed walls of pick-up trucks are typically symmetrical but the size of cargo boxes can vary due to the model type and size of vehicle. Therefore, the present disclosure presents an adjustable internal frame work which provides not only the capability of tautness adjustments after the cover has been removed and stowed, but also fine tuning adjustments for fit of an internal frame work to the vehicle's cargo bed.

A temperature change in weather also affects the cover tautness, allowing the cover to stretch or shrink affecting how the cover fits to the cargo bed. According to embodiments of the present disclosure, located in each corner of the internal frame work are adjustable corners capable of, and useable for, the ability to increase or decrease the distance between the hidden snaps. These corner adjusters have the ability to slide in and out of the internal frame work's side, fore and aft rails. Each, adjustable corner incorporates two adjusting screws to allow corner movement for increasing or decreasing cover tautness.

The present disclosure's internal frame work also provides the ability to accept a series of clamps used to secure the internal frame work to the cargo bed.

The hidden snap assemblies of the present disclosure are used in making the connection between the cover and the internal frame work and employ a collapsible circular configuration being of a larger diameter than a horizontal longitudinal slotted opening which extend the full distance of the side, fore and aft rails of the internal frame work.

The longitudinal slot opening within the outer frame rails allow the hidden snap assemblies to slide within an incorporated cavity spanning the distance of the outer side rails. This results in cover opening and closing capabilities which can be used to access stowed cargo or when it may be necessary, to haul a load which may exceed the height of the cargo bed.

### BRIEF DESCRIPTION OF THE DRAWINGS

FIG. 1 illustrates a pick-up truck cargo bed with an internal frame work attached by a series of clamps.

FIG. 2 illustrates the integration of corner adjusters in relationship to the outer rails of a frame work for a pickup truck cargo bed.

FIG. 3 illustrates an enlarged, cross-sectional view of a circular collapsible snap housed within the outer rail.

### DETAILED DESCRIPTION OF THE PREFERRED EMBODIMENTS

The structure and the technical aspects adopted by the present invention to achieve the above and other objects can be best understood by referring to the following detailed description of the accompanying drawings.

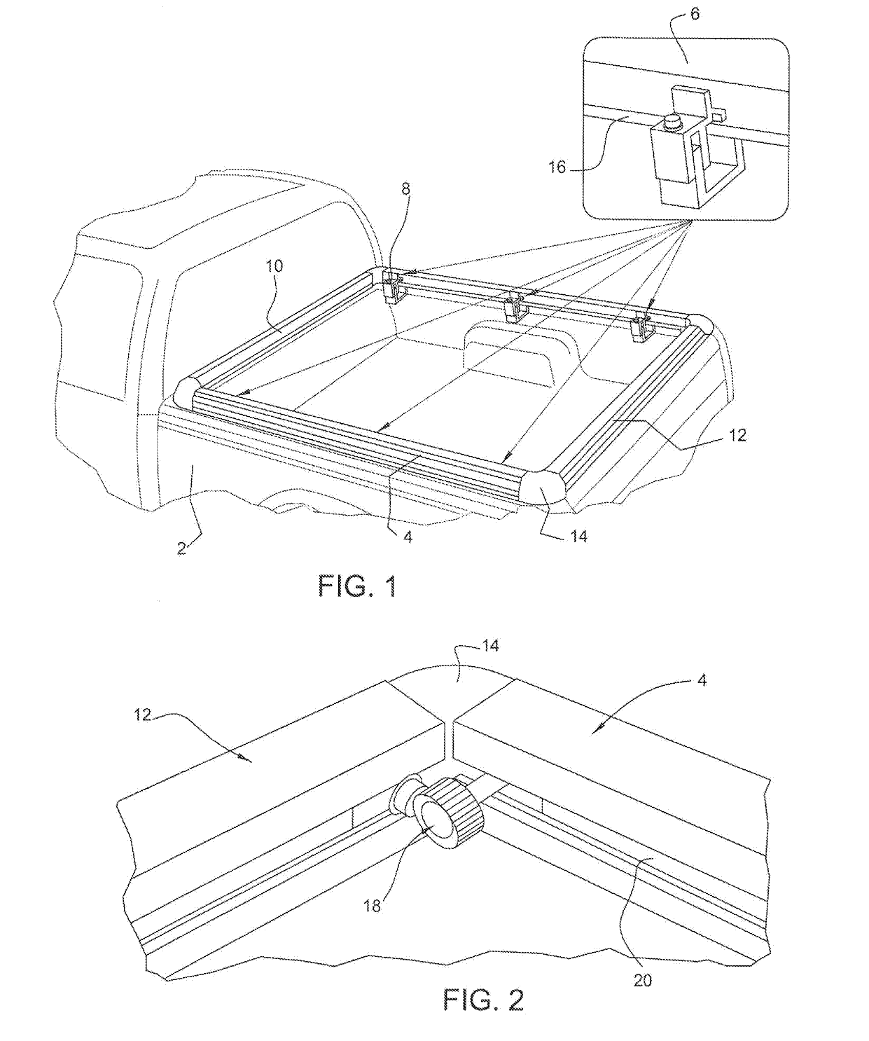

FIG. 1 illustrates a pickup truck cargo bed 2 having an internal frame work held down by a series of clamps 6. The internal frame work is used to align and secure the covering system to the cargo bed. The internal frame includes two outward rails 4 and 8 with both having a connection to fore and aft rails 10 and 12. The internal frame work is designed to rest on the top wall surfaces of the cargo bed and wherein the outward rails include a machined mounting surface used for interfacing the clamps to the internal frame work. The clamps make the connection between the machined surfaces areas to an incorporated lip area 16, located just below the top surface of the cargo bed's side walls. Once the clamps have been tightened they provide sandwiching of the outward rails to the top wall surfaces of the cargo bed.

With reference to FIG. 2, corner 14 interacts to connect outward internal frame rails 4 and 8 to fore and aft rails 10 and 12 and where the four corner sections are allowed back and forth slide-able adjustment within hollowed chamber 20 located within the side, fore and aft rails. The corners are equipped with an adjustment screw 18 which is used to provide surface alignment adjustments of the internal frame work in accordance with the top wall surfaces of the cargo bed.

Further corner sections 14 provide tautness adjustments for the cover if shrinkage of the cover occurs after storage of the cover. Corner adjusting screw 18, when loosened, allows the side rails to retract inwardly towards the cargo bed providing a lesser span across the cargo bed. Alternatively, if cover expansion occurs due to warm weather exposure, corner screw 18 can be tightened causing outward rail repulsion towards the outside cargo bed walls, this results in the tightening of the cover across the cargo bed span.

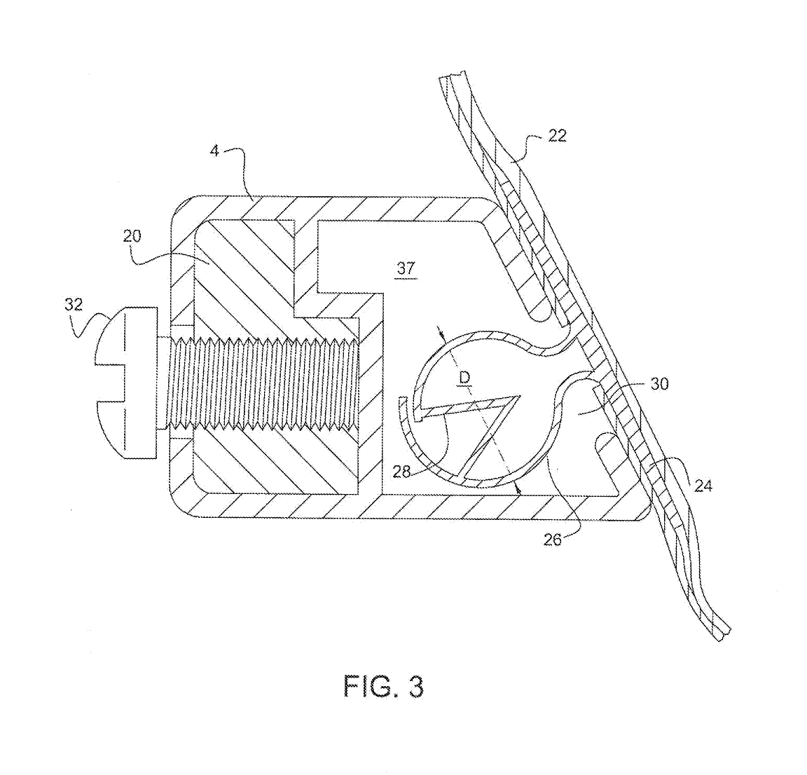

Now, in reference to FIG. 3, secondary hollowed section 20 accepts corner pieces 14 and locking screw 32, used to lock in place the fore and aft rails 10 and 12 to outward rails 4 and 8. Once accomplished, the internal frame work is formed and ready for alignment to the cargo bed.

Fabric or flexible cover 22 is designed to incorporate a series of hidden snap heads 26 covered by an outer layer of cover 22. Once integrated, as at 24, into the fabric or flexible cover 22, the snap heads 26 protrude towards incorporated longitudinal hollow cavities 37 located within at least the outward side rails and fore and aft rails. The snap heads 26 can be incorporated into the cover by sewing the snap heads 26 to the fabric of a flexible cover.

The longitudinal cavity 37 spans at least a portion of the length, preferably at least most of the length, and in some cases, the entire length of the rail. The center rails, may, but are not necessarily provided with the longitudinal cavity. These longitudinal cavities 37 receive the snap heads 26 which snap heads 26 are collapsible, and collapse upon entry into the cavity opening 30 and expand once clear of opening 30. Collapsible snap heads 26, after entry into hollow cavity 37 are retained inside the rail cavity 37 by reason of having a larger head diameter D than cavity opening 30. The collapsible snap heads 26 are constructed of a plastic or a similar collapsible material whereby the snap head 26 is designed to collapse by providing a collapsible pivot point 28. This pivot point 28 provides a collapsible spring action upon entry pressure into the hollowed cavity opening and where, after collapse, the snap head returns back to, or nearly back to, its original circular configuration of diameter D once it has cleared opening 30 by spring action.

Once all snap heads 26 have been installed along the cavity opening 37, the snap heads 26 are free to self-align along the length of the cavity 37 in the rail, due to a non-interference fit of the snap head 26 within cavity 37. This clearance allows the snap head 26 to slide freely inside the longitudinal cavity 37 allowing the fabric cover to be slid open for accessing stowed cargo or during removal or installation.

The above description of the invention reveals certain embodiments, including what would be obvious variants of the disclosed embodiments to one skilled in the art, upon reading the instant disclosure, by reference to the accompanying drawings and appended claims, and where such variations of the disclosed embodiments are not to be considered as a deviation from the scope of the claims. Therefore such modifications or variants of the disclosure which are obvious to persons skilled in the art upon reading this disclosure are also to be considered included with the scope of the appended claims.

What I claim is:

1. A tonneau cover system for a pickup truck cargo bed comprising:
an internal frame work comprising at least one of a fore, an aft and a side rail;
said at least one rail having incorporated into said rail an internal longitudinal cavity spanning at least a portion of the length of the rail;
wherein the entry into the internal longitudinal cavity is comprised of a series of circular openings;
a cover comprising at least an integrated snap head;
said snap head being collapsible from an original diameter larger than said circular opening to a smaller size permitting entry of said snap head through said circular opening and into said longitudinal cavity, and wherein said snap head is capable of recovery of the snap head to a size larger than said circular opening once the snap head is in said longitudinal cavity;
whereby said snap head is retained within said longitudinal cavity.

2. The system of claim 1, wherein the cover is a fabric cover.

3. The system of claim 1, wherein the cover comprises a series of integrated collapsible snap heads.

4. The system of claim 3, wherein the snap heads are integrated to the cover by sewing.

5. The system of claim 1, further comprising a corner section, whereby said corner section allows rails of the internal frame work to be adjustable when connected together.

6. The system of claim 3, wherein said series of collapsible snap heads are each covered by an outer layer of the fabric cover and wherein each of the snap heads are integrated into the fabric cover by sewing.

7. The system of claim 1, wherein the snap head incorporates a collapsible pivot point activated upon application of pressure and wherein the snap head, once lodged inside the longitudinal cavity, returns back to its original circular configuration.

8. The system of claim 7, wherein the snap head returns to its original circular configuration through spring action.

9. The system of claim 1, wherein the longitudinal cavity offers a noninterference clearance to the snap head for slide-ability of the snap head relative to the cavity once the snap head is lodged into the cavity and has expanded to its original circular configuration.

10. The system of claim 5, wherein said adjustable corner further comprises at least one screw used to secure the corner to one of a fore, an aft or a side rail, and additionally comprises a second, adjusting, screw to permit slide-ability to the fore, aft or side rails to increase or decrease cover tautness.

11. The system of claim 1, further comprising a machined surface on the internal frame work's fore, aft and side rails for clamp mounting.

12. The system of claim 1, further comprising a series of clamps to attach the frame work to a cargo bed of a pickup truck.

13. The system of claim 1, wherein the frame work comprises at least a pair of side rails, a fore and an aft rail and at least one center rail.

14. A tonneau cover system for a pickup truck cargo bed comprising:
an internal frame work comprising a fore, an aft and a pair of side rails;
said rails each comprising an internal longitudinal cavity;
wherein an entry into each of the internal longitudinal cavities is comprised of a series of circular openings;
a cover comprising a series of collapsible integrated snap heads;
each of said snap heads being collapsible from an original diameter larger than said circular opening to a smaller size permitting entry of said snap head through said circular opening and into a respective longitudinal cavity in each of said rails, and wherein said snap head is capable of recovery of the snap head to a size larger than said circular opening once the snap head is in said longitudinal cavity;
whereby said snap heads are retained within said longitudinal cavities.

15. The tonneau cover system of claim 14, further comprising at least one center rail.

16. The tonneau cover system of claim 14, wherein the snap head incorporates a collapsible pivot point activated upon application of pressure and wherein the snap head, once lodged inside the longitudinal cavity, returns back to its original circular configuration.

17. The system of claim 16, wherein the snap head returns to its original circular configuration through spring action.

18. The tonneau cover system of claim 14, wherein the cover is a fabric cover and said series of collapsible snap heads are each covered by an outer layer of the fabric cover and wherein each of the snap heads are integrated into the fabric cover.

19. The system of claim 14, further comprising a corner section, whereby said corner section allows rails of the internal frame work to be adjustable when connected together.
